(19) United States
(12) Patent Application Publication
(10) Pub. No.: US 2013/0113373 A1
(43) Pub. Date: May 9, 2013

(54) ELECTRODELESS PLASMA LIGHTING DEVICE, IN PARTICULAR MICROWAVE LAMP

(71) Applicant: Boris Lutterbach, Muhlheim (DE)

(72) Inventor: Boris Lutterbach, Muhlheim (DE)

(21) Appl. No.: 13/659,362

(22) Filed: Oct. 24, 2012

Related U.S. Application Data
(60) Provisional application No. 61/551,472, filed on Oct. 26, 2011.

(30) Foreign Application Priority Data
Oct. 24, 2011 (DE) 10 2011 054 760.6

(51) Int. Cl. H01J 7/24

(52) U.S. Cl. CPC H01J 7/24
USPC 315/34

(57) ABSTRACT

The invention relates to an electrodeless plasma lighting or illuminating device (microwave lighting device), comprising an illuminant member (2), which is excited by an rf-radiation for illumination and held by a shaft (3), and a supporting member (30) for supporting the shaft (3) together with the illuminant member, wherein the supporting member (30) is coupled with a rotary drive (20) for rotating the supporting member (30) together with the shaft (3) around a longitudinal axis thereof. According to the invention a plurality of supporting spots (37) or point-like supporting members (37) protrude from a surface, preferably an inner surface, of the supporting member (30) for supporting the shaft (3) in a punctual manner. Accordingly the surface contact between the hot shaft (3) and the supporting member is effectively reduced to thereby reduce the efforts required for cooling said shaft, in particular in the region of the supporting member.

### CROSS-REFERENCE TO RELATED APPLICATIONS

The present application claims priority under 35 U.S.C. §119(a) to German Patent Application No. 10 2011 054 760.6, filed on 24 Oct. 2011, entitled “Electrodeless Plasma Lighting Device, in particular Microwave Lamp”, and under 35 U.S.C. §119(e) to U.S. Provisional Application No. 61/551,472, filed on 26 Oct. 2011, entitled “Electrodeless Plasma Lighting Device, in particular Microwave Lamp”, the whole content of each of which is hereby incorporated by reference.

### FIELD OF INVENTION

The present invention relates in general to electrodeless plasma lighting devices and in particular to a mounting assembly or holder of such an electrodeless plasma lighting device, which is substantially thermally decoupled from an illuminant member of such an electrodeless plasma lighting device.

### BACKGROUND OF INVENTION

Such plasma lighting devices, also referred to as a microwave lamp, comprise an illuminant member, which is formed as quartz glass body filled with a noble gas at low pressure, said quartz glass body being coated with a metal halide. The microwave irradiation generates plasma inside the illuminant member, in which the noble gas filling is ionized. The plasma causes the metal halide to be evaporated. Noble gas plasma and metal halide vapor together emit light over a broad spectral range. This spectrum can be changed by doping the coating. Such lamps are characterized in particular by a high light output and lamp life. Conventional plasma lighting devices have a relatively complex structure, which is reflected in higher costs.

For screening or shielding the radio frequency radiation exciting the illuminant member, the illuminant member is usually disposed within a mesh cage serving as a Faraday cage, which is substantially impermeable for the exciting radio frequency radiation, but passes light to a sufficient extent. Within the mesh cage usually a standing wave is formed, which may result in the formation of hot spots and can lead to thermal overload of the illuminant member. To avoid this, usually the illuminant member is moved within the mesh cage. For this purpose, usually rotary supports are used, which are driven by a DC motor to rotate the illuminant member about an axis of rotation.

U.S. Pat. No. 7,583,029 B2 discloses an electrodeless plasma lighting device, comprising an illuminant member, which is excited by a radio-frequency radiation for illumination and is supported by a shaft, and a holding or supporting member which is embodied as a sleeve, one end of which is coupled with the shaft and the other end of which is coupled with the drive shaft of a drive motor for rotating the illuminant member around the longitudinal axis of the shaft. The shaft is bonded into the sleeve or clamped by the latter. Due to the large-area contact the heat from the illuminant member and the shaft is transferred relatively well to the drive shaft and the drive motor, so that the efforts for an active cooling, in particular by means of a fan, are relatively high and so that the active cooling may cause undesirable noise when the lighting device is operated.

U.S. Pat. No. 5,811,936 discloses another electrodeless plasma lighting device, but details of the coupling of the illuminant member are not disclosed to the rotary drive.

DE 453 225 discloses an assembly for bearing a hot shaft rotating at high speed. For this purpose, the shaft is thermally isolated against the bearings by insulating muffles, which are provided at their inner sides with transverse grooves for reducing the contact with the shaft. In this manner additional air spaces are formed, which enhance the thermal insulation.

US 2002/101191 A1 discloses an electrodeless plasma lighting device using ball bearings for support. The illuminant body is disposed on a first side of a cover of a housing of the plasma lighting device and the shaft of the illuminant body extends through the housing up to a second side of the housing, where a rotary drive is disposed.

US 2003/057842 A1 and U.S. Pat. No. 5,811,936 disclose further plasma lighting devices, where the rotary drive is, however, mounted under a different geometry at a housing of the plasma lighting device.

### SUMMARY OF INVENTION

It is an object of the present invention to further enhance an electrodeless plasma lighting device of the kind disclosed by U.S. Pat. No. 7,583,029 B2 such that the efforts for cooling can be reduced and in particular the heat transfer from the illuminant member to a rotary drive and a bearing of the plasma lighting device can be further reduced.

According to the present invention this problem is solved by an electrodeless plasma lighting device according to claim 1. Further advantageous embodiments are the subject-matter of the dependent claims.

According to the present invention a plurality of contact or supporting spots or point-like supporting members protrude from a surface, preferably from in inner surface, of the supporting member for supporting the shaft, so that said shaft is only supported in a punctual manner, i.e. only by the plurality of contact spots or point-like supporting members, but not by means of a full-area contact with the supporting member. Because of the relatively small contact area between the hot shaft and the supporting member the heat transfer from the illuminant member via the shaft and the supporting member towards the rotary drive is effectively reduced so that the efforts for cooling the supporting member and the drive shaft of the driving motor can be significantly reduced. Furthermore, also the configuration of the lighting (illuminating) device can be simplified in this region resulting in reduced costs. Overall, a reliable continuous operation can be accomplished in a simple manner.

Preferably, the plurality of contact spots or point-like supporting members are flexible or resilient and are provided on a surface of the supporting member and pushed downward upon insertion of the supporting shaft. In general, these contact points may be matched, however, precisely to the size of the shaft so that they may also be supported in a non-resilient manner on the surface of the supporting member. In particular, they may be formed integrally with the supporting member.

According to a further embodiment the supporting member is formed as an accommodating sleeve, into which the shaft of the illuminant body is inserted, wherein the contact spots protrude from an inner surface of the accommodating sleeve. Here, it is preferred, that the shaft is received asymmetrically by the accommodating sleeve, because clamping forces may then act symmetrically on the shaft.

According to a further embodiment the plurality of contact spots or point-like supporting members are disposed at equally spaced angular positions on the inner surface of the accommodating sleeve in a distributed manner and under identical spacings to the inner surface of the accommodating sleeve.

According to a further embodiment the contact spots or point-like supporting members are formed on front ends of resilient tongues, which are resiliently supported on the inner surface of the accommodating sleeve or formed by said accommodating sleeve. The resilient tongues may be used as separate members in the interior of the accommodating sleeve. But they can also be formed integrally with the accommodating sleeve, as outlined below. Preferably, the clearance of a receptacle formed by these resilient tongues is slightly smaller than a maximum outer diameter of said shaft so that the shaft is slightly clamped in the inner bore of the accommodating sleeve.

According to a further embodiment the resilient tongues are respectively formed by a recess and by two longitudinal slots in the accommodating sleeve. The resilient tongues may be bent slightly inward so that they then may also protrude from the inner surface of the accommodating sleeve.

The recesses and/or longitudinal slots may be formed in the accommodating sleeve in such a manner that a vortex-like cooling air flow is formed for cooling the shaft and the accommodating sleeve when the accommodating sleeve is rotated, which is suited for cooling said shaft. This helps to efficiently reduce the efforts for cooling, in particular in this region.

According to a further embodiment the illuminant member is disposed on a first side of a cover of a housing of said plasma lighting device, wherein the supporting member extends through the housing portion up to a second opposite side of said cover and is coupled with the rotary drive at said second side. The housing portion may thus also serve as an rf-screening or as a side-wall of a microwave guide of the lighting device.

According to a further embodiment the drive shaft of the rotary drive is coupled with an end of the supporting member averted from the illuminant member without a direct contact to said shaft, in particular in a rotary fixed manner. The holding member, e.g. the afore-mentioned accommodating sleeve, may thus be coupled with the drive shaft of the rotary drive at the averted end. Here, the shaft is preferably received at the averted end of the supporting member. Thus, the heat transfer from the shaft to the drive shaft and the drive motor is further reduced.

According to a further embodiment the rotary drive is mounted to an intermediate plate which is mounted to an additional massive (bulk) plate which supports a bearing for bearing the supporting member. Here, this massive (bulk) plate of a metal serves for an effective dissipation of heat so that the thermal load of the rotary drive, in particular of a DC motor, may be further reduced. This also holds for the thermal load of the bearing for bearing the supporting member.

According to a further embodiment the supporting member has a higher thermal conductivity than the housing portion of the plasma lighting device and/or than the afore-mentioned intermediate plate so that the heat may be dissipated even more efficiently.

### OVERVIEW ON DRAWINGS

Hereinafter the present invention will be described in an exemplary manner and with reference to the appended drawings, from which further features, advantages and problems to be solved may be derived and wherein:

FIG. 1 shows in a partial cross-section the coupling of a cylindrical accommodating sleeve for supporting the shaft of an illuminant member with an electric motor according to the present invention;

FIG. 2a shows a cylindrical accommodating sleeve according to another embodiment according to the present invention;

FIG. 2b shows the accommodating sleeve of FIG. 2a in a schematic top view;

FIG. 3 shows the support of the shaft of an illuminant member in a cylindrical accommodating sleeve according to another embodiment according to the present invention;

FIG. 4 shows the accommodating sleeve of FIG. 3 in a schematic top view;

FIG. 5 shows a plasma lighting (illuminating) device according to another embodiment of to the present invention in a partial sectional view.

Throughout the drawings the same reference numbers relate to identical or substantially equivalent elements or groups of elements.

### DETAILED DESCRIPTION OF PREFERRED EMBODIMENTS

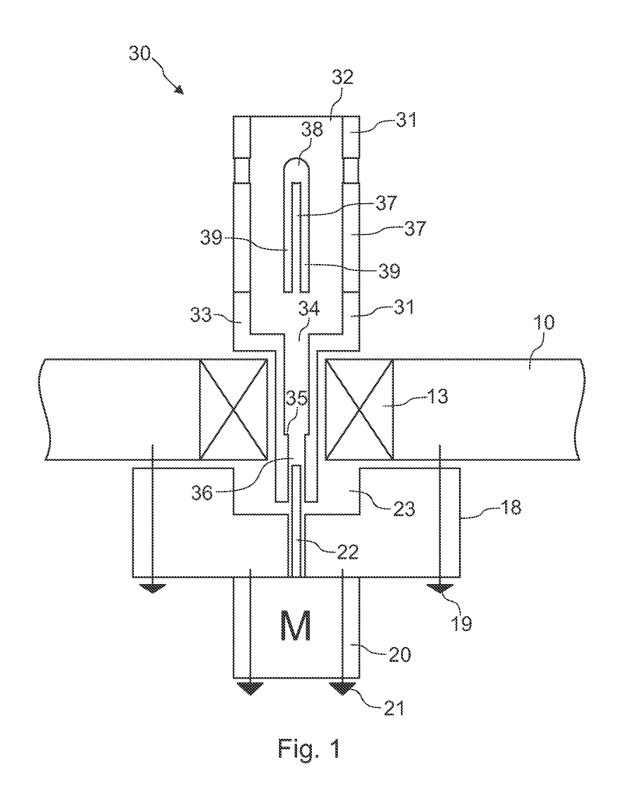

FIG. 1 shows in a partial section the mounting of a supporting member 30 serving as the accommodating cylinder 31 and its coupling with a DC motor 20 according to the present invention. The motor 20 and the accommodating cylinder 31 are disposed on opposite sides of a cover 10, which may be a cover of a plasma lighting device. The accommodating cylinder 31 has a cylindrical inner bore 32, in which the stem (shaft) of an illuminant member is to be supported. The inner bore 32 is tapered at the bottom 33 and passes into a connecting hole 34 having a smaller inner diameter, at the lower end of which the coupling with the motor shaft 22 of the motor 20 is accomplished. For this purpose, the motor shaft 22 can simply be connected by means of screws to the lower end of the supporting member 30. Such a connecting screw may for example be accessible from the side of the adapter 18 via a recess 23.

According to FIG. 1, the motor 20 is fixed by means of screws 21 to the intermediate plate 18, which in turn is secured by means of screws 19 to the cover 10. On the upper side of the intermediate plate 18, a recess 23 is formed to make a distance from the outer wall of the lower end of the supporting member 30 as large as possible.

The supporting member 30 is rotatably mounted in the cover 10 by means of the bearing 13. For supporting the stem or shaft of the illuminant member, the inner bore 32 of the supporting member 30 is slightly wider than the outer diameter of the shaft. For supporting the shaft a plurality of contact points protrude from the inner surface of the accommodating cylinder 31. The shaft itself is supported only in a punctual manner at these contact points, but does not, however, contact the entire surface on the inner surface of the accommodating cylinder 31. For this purpose, according to FIG. 1 a plurality of resilient tongues 37 are formed in the supporting member 30, namely by means of the bore 38 into which the two parallel slots 39 extend, wherein the resilient tongues 37 are formed between these slots. The resilient tongues 37 may then be pressed slightly inwardly to protrude slightly from the inner surface of the accommodating cylinder 31 and act as contact points. As is evident from FIG. 1, the plurality of resilient fingers 37 are distributed at equal angular intervals to each other along the inner circumference and at the same level. Although it is shown in FIG. 1 that at an angular position only one resilient tongue 37 or only one contact point is formed, according to further embodiments (not shown) more than one contact point, in particular two contact points, may be formed at an angular position, which then may be disposed at different axial positions along the accommodating cylinder 31.

Instead of the aforementioned resilient tongues 37 only quite a few raised portions may be formed on the inner surface of the accommodating cylinder 31, which may in particular be integrally formed with the accommodating cylinder or attached to the latter. Such contact points are used to support the shaft of the illuminant member, as described below in more detail.

As can be seen from FIG. 1, a contact between the shaft of the illuminant member and the motor shaft 22 is effectively prevented. Heat dissipation via the constricted connecting bore 34 toward the motor shaft 22 is effectively reduced.

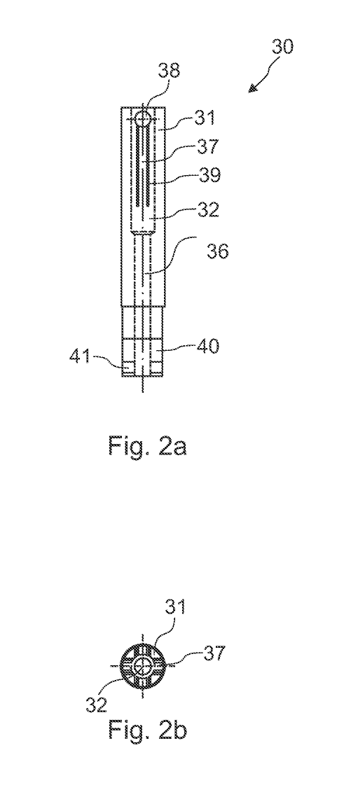

FIG. 2a shows a supporting member 30 according to another embodiment of the present invention, which basically has different proportions, however, in principle has the same configuration as explained above with reference to FIG. 1, and comprises in particular resilient tongues 37 formed in a comparable manner. In the lower sleeve 40 of the supporting member 30 a radial threaded bore 41 is shown for receiving a screw, which is to clamp the motor shaft (see FIG. 1) of the motor.

FIG. 2b shows the supporting member according to FIG. 2a in a schematic plan view, wherein it is apparent that the cylindrical inner bore 32 is formed concentrically to the accommodating cylinder 31.

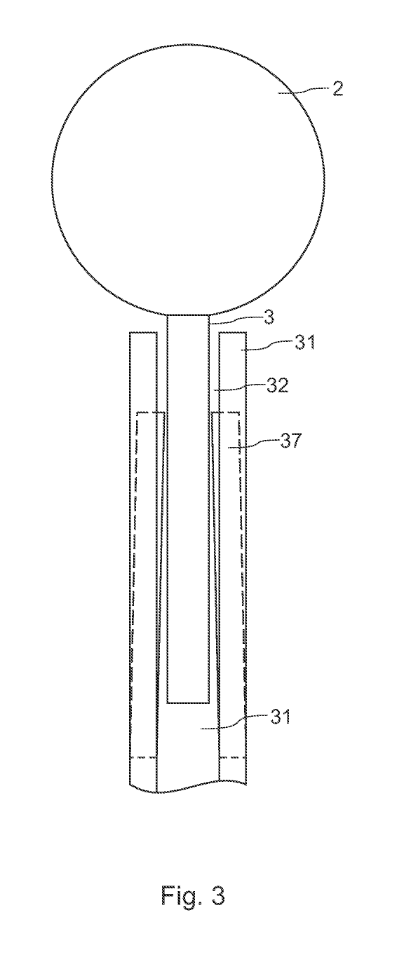

FIG. 3 shows the clamping of the shaft 3 of an illuminant member 2 in an accommodating cylinder 31, as described above, wherein a plurality of resilient tongues 37 are formed in the side walls of the accommodating cylinder 31 in the manner described above, which are bent slightly inwardly and press against the shaft 3 to clamp it. Because the resilient tongues 37 are disposed along the inner circumference of the accommodating cylinder 31 and distributed at equal angular distances from one another, the shaft 3 is clamped symmetrically within the inner bore 32 so that the shaft 3 does not contact the inner surface of the receiving cylinder 31 at any point. Rather, the shaft 3 is held centrally relative to the inner bore 32 of the accommodating cylinder 31, so that a uniform annular gap is formed between the shaft 3 and the accommodating cylinder 31.

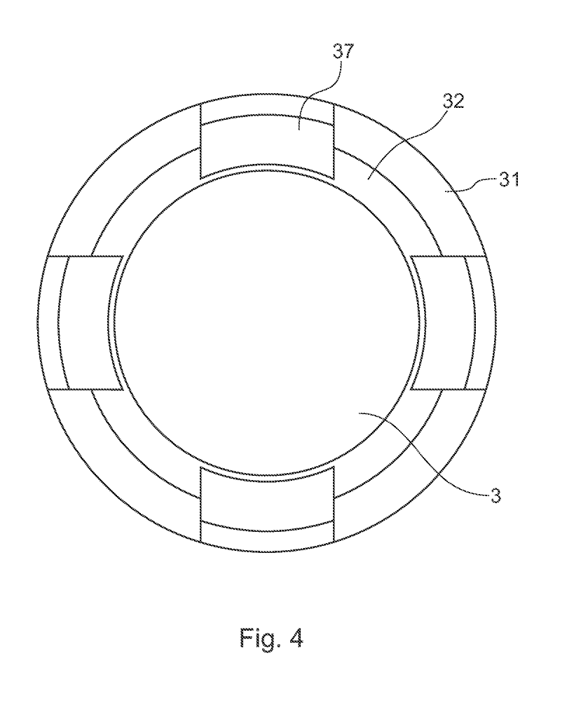

FIG. 4 shows the accommodating sleeve 31 according to FIG. 3 in a schematic plan view. It is apparent that the resilient tongues 37 are slightly bent inwardly and into the inner bore 32, and thus project slightly from the inner surface of the accommodating cylinder 31. The shaft 3 is supported only in the region of the front ends of the resilient tongues 37 acting as contact points and in particular does not contact the inner surface of the accommodating cylinder 31.

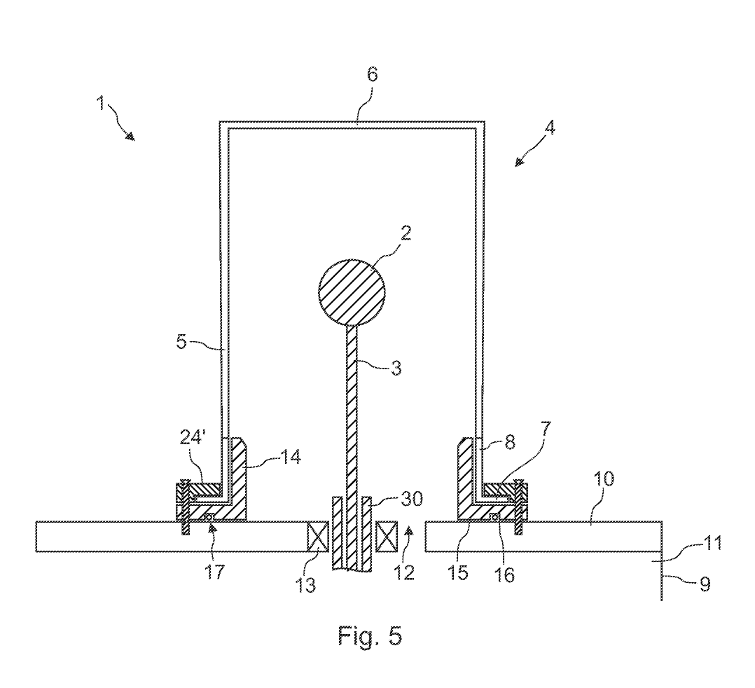

FIG. 5 shows the further configuration of an electrodeless plasma lighting device 1 according to the present invention. According to FIG. 5 the illuminant member 2 is disposed on one side of the upper cover 10 of the housing 9 of the plasma lighting device 1. The shaft 3 is in this case received in the manner described above in the supporting member 30, which protrudes through the cover 10. The supporting member 30 is rotatably supported on the cover 10 by a bearing 13. On the top side of the cover 10 an rf-screening cage 4 is disposed, which is formed by a side member 5 and an upper cover 6, which are joined or connected with each other and are made of or coated by an electrically conductive material, particularly a thin metal sheet. The side member 5 is formed as a metal mesh or metal screen and together with the cover 6 acts as a Faraday cage. The lower end of the side member 5 is preferably formed without apertures and serves as a contact or supporting surface 8, which is supported on the holding cylinder 14. At the bottom of the contact surface 8, a plurality of bent or folded fingers are formed, which rest on the upper side of the supporting cylinder 14 and which are pressed against the supporting cylinder 14 by means of a pressing ring 24′. For this purpose screws are used, which press the pressing ring 24′ against the cover 10. Thus, an rf-sealing member 17 of an electrically conductive material, which is accommodated in an annular groove 16 on the bottom side of the supporting cylinder 14, is pressed or compressed, so that any leakage of rf-radiation at the lower edge of the screening cage is prevented. The cover 10 may constitute the top of a microwave waveguide 11 for guiding a microwave radiation or rf-radiation from a magnetron (not shown) via the coupling-out opening 12 in the interior of the screening cage in order to excite the illuminant member 2.

### LIST OF REFERENCE NUMBERS

1 lighting (illuminating) device
2 illuminant member
3 stem/shaft
4 screening or rf-screening cage
5 side member
6 cover member
7 finger
8 supporting or abutment face
9 housing
10 upper cover
11 waveguide
12 rf-coupling opening
13 bearing
14 tubular member/cylinder
15 flange
16 recess
17 rf-sealing member
18 adapter
19 screw
20 motor
21 screw
22 motor shaft
23 recess
24 pressing ring
30 holding or supporting member
31 accommodating cylinder or sleeve
32 inner bore
33 bottom
34 connecting bore
35 step
36 inner bore having a smaller diameter
37 tongue
38 bore/recess
39 slot
40 lower sleeve
41 threaded bore

1. An electrodeless plasma lighting device, comprising
an illuminant member, which is excited by an rf-radiation for illumination and supported by a shaft; and
a supporting member for supporting the shaft together with the illuminant member; wherein
the supporting member is coupled with a rotary drive for rotating the supporting member together with the shaft around a longitudinal axis thereof;
a plurality of contact spots or point-like supporting members protrude from a surface of the supporting member for supporting the shaft in a punctual manner;
said supporting member is formed as an accommodating sleeve;
the plurality of contact spots or point-like supporting members are formed at front ends of elastic or resilient tongues or are formed by these elastic or resilient tongues;
a receptacle is formed by said elastic or resilient tongues for accommodating said shaft; and
a clearance of said receptacle is slightly smaller than a maximum outer diameter of said shaft

2. The electrodeless plasma lighting device as claimed in claim 1, wherein the plurality of contact spots or point-like supporting members are flexible or resilient and are provided on a surface of the supporting member or are formed by said supporting member.

3. The electrodeless plasma lighting device as claimed in claim 1, wherein the plurality of contact spots or point-like supporting members are disposed at equally spaced angular positions on the inner surface of the accommodating sleeve in a distributed manner and under identical spacings to the inner surface of the accommodating sleeve.

4. The electrodeless plasma lighting device as claimed in claim 4, wherein the elastic or resilient tongues are respectively formed by a recess and by two longitudinal slots in the accommodating sleeve, which extend into said recess.

5. The electrodeless plasma lighting device as claimed in claim 4, wherein the recesses and/or longitudinal slots are formed in the accommodating sleeve in such a manner that an air flow is formed, which is suited for cooling said shaft.

6. The electrodeless plasma lighting device as claimed in claim 1, wherein
the illuminant member is disposed on a first side of a cover of a housing of said plasma lighting device and
the supporting member extends through said housing portion up to a second opposite side of said cover and is coupled with the rotary drive at said second side.

7. The electrodeless plasma lighting device as claimed in claim 6, wherein a drive shaft of said rotary drive is coupled with an end of said supporting member averted from said illuminant member without a direct contact to said shaft.

8. The electrodeless plasma lighting device as claimed in claim 7, wherein said drive shaft of said rotary drive is coupled with said end of said supporting member in a rotary fixed manner.

9. The electrodeless plasma lighting device as claimed in claim 7, wherein said end of the supporting member, which is avertet from said illuminant member, is formed as an accommodating sleeve for accommodating said drive shaft with a smaller inner diameter than said accommodating sleeve for said shaft.

10. The electrodeless plasma lighting device as claimed in claim 1, wherein the rotary drive is mounted to an intermediate plate which is mounted to a massive plate which supports a bearing for bearing said supporting member.

11. The electrodeless plasma lighting device as claimed in claim 10, wherein the supporting member has a higher thermal conductivity than the housing portion of the plasma lighting device and/or than said intermediate plate.
